(19) United States
(12) Patent Application Publication
(10) Pub. No.: US 2014/0112522 A1
(43) Pub. Date: Apr. 24, 2014

(54) AUDIO MODULE MOUNTING APPARATUS

(71) Applicant: HON HAI PRECISION INDUSTRY CO., LTD., New Taipei (TW)

(72) Inventors: SHIH-FENG LU, New Taipei (TW); SHIANG-HUI WEI, New Taipei (TW); CHIA-JUNG LIU, New Taipei (TW); YI-RU LAI, New Taipei (TW)

(21) Appl. No.: 13/928,729

(22) Filed: Jun. 27, 2013

(30) Foreign Application Priority Data
Oct. 18, 2012 (TW) 101138463

(51) Int. Cl. H04R 1/02

(52) U.S. Cl. CPC H04R 1/026
USPC 381/387

(57) ABSTRACT

A mounting apparatus for an audio module includes an enclosure base and an enclosure cover. The audio module is pivotally mounted in the enclosure base. A first rotating rod is positioned on the sides of the audio module. An elastic member is mounted on and a plurality of first teeth protrude from one side of the first rotating rod. A gear is pivotally mounted in the enclosure base. A plurality of second teeth protrude from the gear corresponding to the plurality of first teeth. The elastic member is elastically deformed in its original state, and the audio module is received in the enclosure base. When the enclosure cover is rotated away from the enclosure base, the elastic member rotates the first rotating rod, the first rotating rod rotates the gear, and the audio module extends to outside of the enclosure base.

### BACKGROUND

1. Technical Field

The present disclosure relates to a mounting apparatus for an audio module.

2. Description of Related Art

Electronic devices such as notebooks usually include an enclosure base and an enclosure cover pivotally mounted on the enclosure base. An audio module is installed in the enclosure base to generate audio signals. A number of sound output holes are defined in the audio module to output sound. The sound output holes are usually hidden in the enclosure base so that the emitted sound becomes muffled, which influences the tone and quality of the sound.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of an embodiment of a mounting apparatus for an audio module.

FIG. 2 is an enlarged view of a circled portion II of FIG. 1.

FIG. 3 is an enlarged view of a circled portion III of FIG. 1.

FIG. 4 is an assembled view of the mounting apparatus for the audio module of FIG. 1.

FIG. 5 is an enlarged view of a circled portion V of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

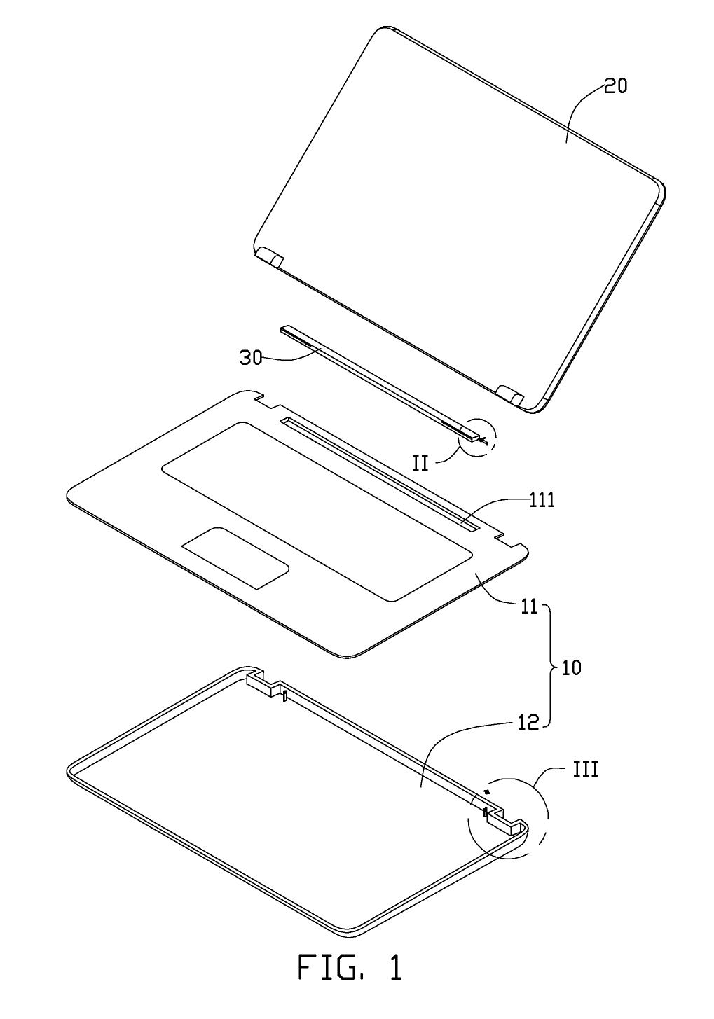

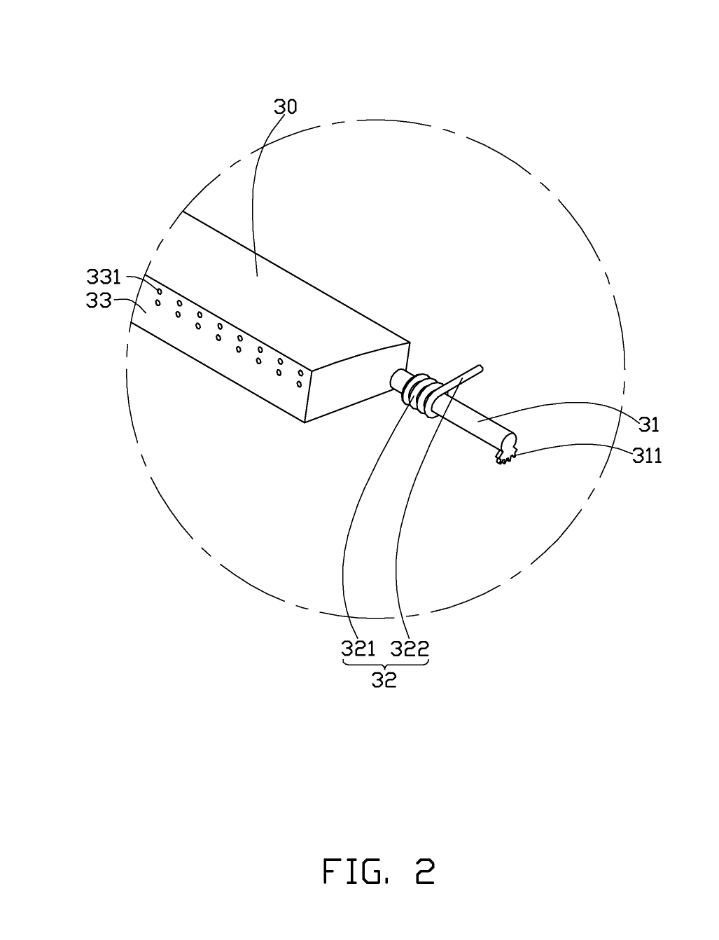

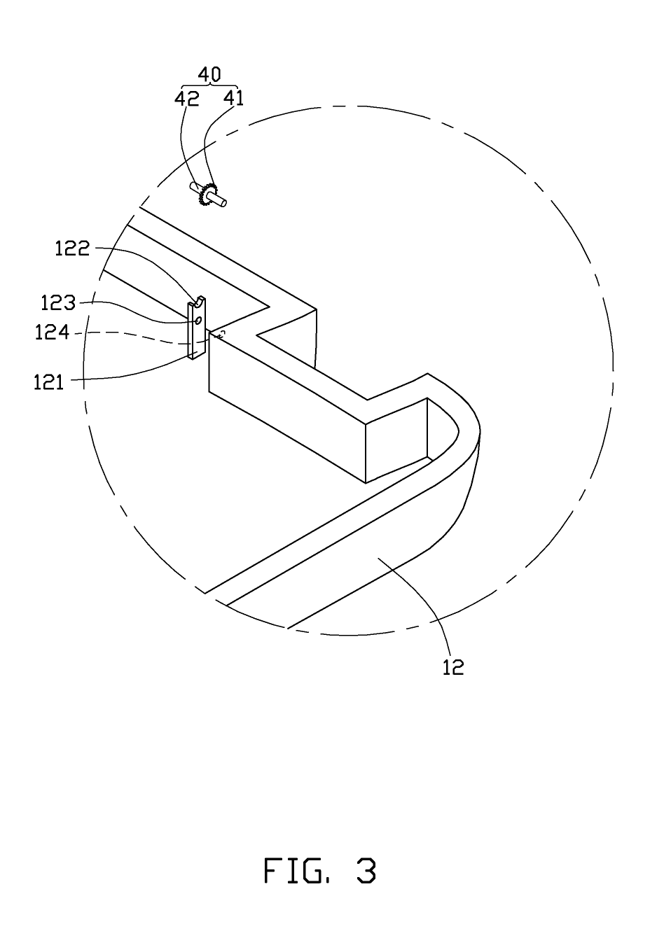

FIGS. 1 to 3 show a mounting apparatus for an audio module. The mounting apparatus includes an enclosure base 10, an enclosure cover 20 pivotally mounted on the enclosure base 10, and an audio module 30 pivotally installed in the enclosure base 10.

The enclosure base 10 includes a top plate 11 and a bottom plate 12. A mounting slot 111 is defined in the top plate 11. The audio module 30 is received in the top plate 11. Two first rotating rods 31 are positioned on two sides of the audio module 30. One rotating rod 31 has a plurality of first teeth 311 protruding from it and an elastic member 32 mounted on it. The elastic member 32 includes a winding portion 321 and a resisting portion 322. The audio module 30 includes a side surface 33. A plurality of sound output holes 331 are defined in the side surface 33.

Two supporting plates 121 perpendicularly extend from a top surface of the bottom plate 12. A pivoting slot 122 is defined in the top of the two supporting plates 121. The two first rotating rods 31 are pivotally mounted in the pivoting slots 122. A gear 40 is pivotally mounted in the bottom plate 12. A plurality of second teeth 41 protrude from the gear 40 corresponding to the plurality of first teeth 311. A second rotating rod 42 extends from the gear 40. A first mounting hole 123 is defined in one of the two supporting plates 121. A second mounting hole 124 is defined in the bottom plate 12. Two distal ends of the second rotating rod 42 are pivotally mounted in the first mounting hole 123 and the second mounting hole 124. In one embodiment, the pivoting slots 122 are arc-shaped and conform to the shape of the first rotating rods 31. Likewise, the shape of the second rotating rod 42 conforms to the shapes of the first mounting hole 123 and the second mounting hole 124. In this embodiment, the elastic member 32 is a torsion spring.

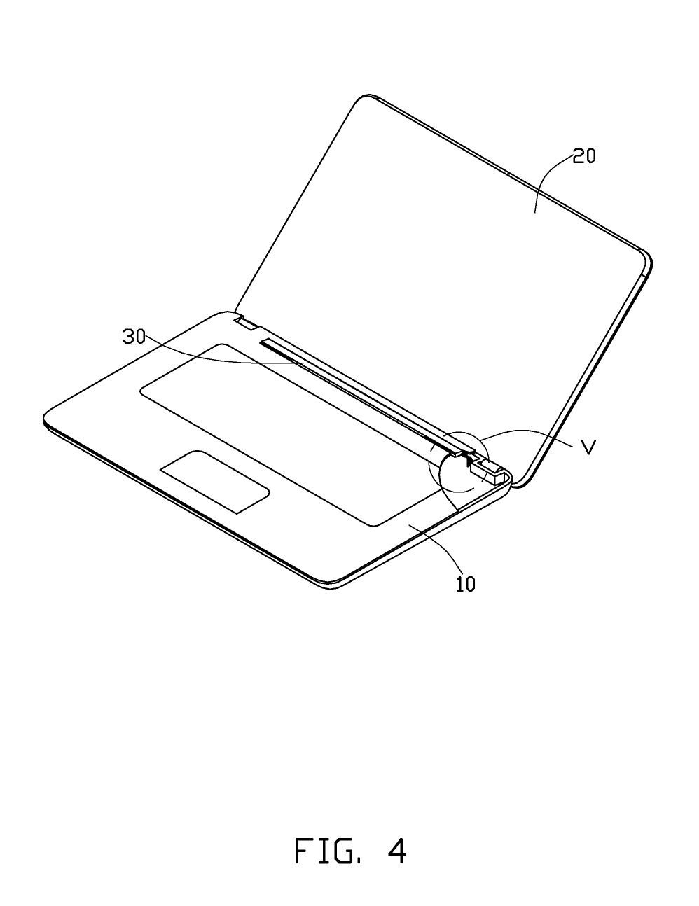

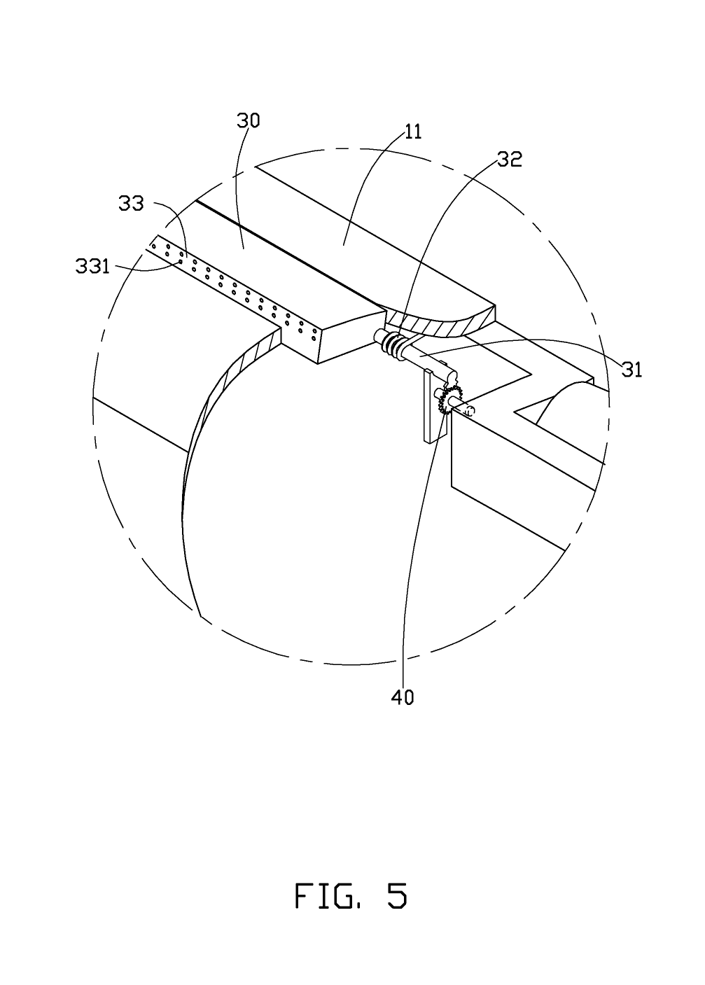

FIGS. 1 to 5 show that in assembly, the audio module 30 is located in the bottom plate 12. The two first rotating rods 31 are received in the two pivoting slots 122. The two distal ends of the second rotating rod 42 pass through the first mounting hole 123 and the second mounting hole 124. The plurality of second teeth 41 engages the plurality of first teeth 311. The top plate 11 is installed on the bottom plate 12. The audio module 30 is received by the mounting slot 111. A height of the side 33 is higher than a height of the top plate 11. The plurality of sound output holes 331 are positioned outside of the mounting slot 111. A bottom surface of the top plate 11 resists against the resisting portion 322 of the elastic member 32. The elastic member 32 is elastically deformed slightly in its original state. The enclosure cover 20 is pivotally mounted on the enclosure base 10.

When the enclosure cover 20 is rotated toward the enclosure base 10, the cover 20 resists against the top surface of the audio module 30. The resisting portion 322 of the elastic member 32 resists against the bottom surface of the top plate 11, which rotates the two first rotating rods 31 along a first direction. The first teeth 311 engage the second teeth 41 to move the gear 40 along a second direction. The elastic member 32 is further elastically deformed so that the side surface 33 is received in the mounting slot 111 and the plurality of sound output holes 331 do not extend outside of the mounting slot 111.

When the enclosure cover 20 is rotated away from the enclosure base 10, the enclosure cover 20 does not resist against the top surface of the audio module 30. The elastic member 32 is elastically returned to its original state and rotates the first rotating rods 31 along the second direction. The first teeth 311 engage the second teeth 41 to move the gear 40 along the first direction. The first rotating rods 31 rotate the audio module 30, and the side surface 33 and the plurality of sound output holes 331 extend outside the mounting slot 111.

In one embodiment, the first direction is counterclockwise, and the second direction is clockwise. The gear 40 absorbs the elastic force of the elastic member 32 when it is elastically returned, so the side surface 33 can extend outside of the mounting slot 111 slowly and smoothly.

In another embodiment, each of the two first rotating rods 31 has a plurality of first teeth 311 protruding from it and an elastic member 32 mounted on it. A first mounting hole 123 is defined in each of the two supporting plates 121. Two second mounting holes 124 are defined in the bottom plate 12. And two gears 40 are pivotally mounted in the bottom plate 12 to further absorb the elastic force of the elastic members 32. When the enclosure cover 20 is rotated away from the enclosure base 10, the elastic members 32 are elastically returned to there original state and rotate the first rotating rods 31 along the second direction. The gears 40 absorb the elastic force of the elastic members 32 when they are elastically returned, so the side surface 33 can extend outside of the mounting slot 111 slowly and smoothly.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A mounting apparatus for audio module comprising:
an enclosure base;
an enclosure cover pivotally mounted on the enclosure base; and
an audio module pivotally installed in the enclosure base; wherein a first rotating rod is positioned on the audio module; an elastic member is mounted on the first rotating rod; a plurality of first teeth protrude from the first rotating rod; a gear is pivotally mounted on the enclosure base; a plurality of second teeth protrude from the gear corresponding to the plurality of first teeth; when the enclosure cover is rotated toward the enclosure base, the elastic member is elastically deformed, the audio module is received in the enclosure base; and when the enclosure cover is rotated away from the enclosure base, the elastic member is elastically returned and rotates the first rotating rod, the plurality of first teeth engage the plurality of second teeth the first rotating rod rotates the gear; and the audio module extends to outside of the enclosure base.

2. The mounting apparatus for audio module of claim 1, wherein the enclosure base comprises a mounting slot; and the audio module is received in the mounting slot.

3. The mounting apparatus for audio module of claim 1, wherein the elastic member comprises a winding portion and a resisting portion the winding portion is mounted on the first rotating rod; and the resisting portion resists against the enclosure base.

4. The mounting apparatus for audio module of claim 1, further comprising a supporting plate extends from the enclosure base; a pivoting slot is defined at a top of the supporting plate; and the first rotating rod is pivotally mounted in the pivoting slot.

5. The mounting apparatus for audio module of claim 4, wherein the pivoting slot is arc-shaped; and a dimension of the first rotating rod is equal to a dimension of the pivoting slot.

6. The mounting apparatus for audio module of claim 4, further comprising a second rotating rod extending from the gear; a first mounting hole is defined in the supporting plate; a second mounting hole is defined in the enclosure base; and two distal ends of the second rotating rod are pivotally mounted in the first mounting hole and the second mounting hole respectively.

7. The mounting apparatus for audio module of claim 6, wherein a dimension of the second rotating rod is equal to a dimension of the first mounting hole and a dimension of the second mounting hole.

8. The mounting apparatus for audio module of claim 1, wherein the first rotating rod rotates along a direction opposite to a rotational direction of the gear.

9. The mounting apparatus for audio module of claim 1, wherein the elastic member is a torsion spring.

10. The mounting apparatus for audio module of claim 1, wherein the audio module comprises a side surface; and a plurality of sound output holes are defined in the side surface.

11. A mounting apparatus for audio module comprising:
an enclosure base;
an enclosure cover pivotally mounted on the enclosure base; and
an audio module pivotally installed in the enclosure base; wherein a first rotating rod is positioned on the audio module; an elastic member is mounted on the first rotating rod; a plurality of first teeth protrude from the first rotating rod; a gear is pivotally mounted on the enclosure base; a plurality of second teeth protrude from the gear corresponding to the plurality of first teeth; the elastic member is elastically deformed at an original state, the audio module is received in the enclosure base; when the enclosure cover is rotated away from the enclosure base, the elastic member is elastically returned and rotates the first rotating rod, the plurality of first teeth engage the plurality of second teeth; the first rotating rod rotates the gear; and the audio module extends to outside of the enclosure base.

12. The mounting apparatus for audio module of claim 11, wherein the enclosure base comprises a mounting slot; and the audio module is received in the mounting slot.

13. The mounting apparatus for audio module of claim 11, wherein the elastic member comprises a winding portion and a resisting portion; the winding portion is mounted on the first rotating rod; and the resisting portion resists against the enclosure base.

14. The mounting apparatus for audio module of claim 11, further comprising a supporting plate extends from the enclosure base; a pivoting slot is defined at a top of the supporting plate; and the first rotating rod is pivotally mounted in the pivoting slot.

15. The mounting apparatus for audio module of claim 14, wherein the pivoting slot is arc-shaped; and a dimension of the first rotating rod is equal to a dimension of the pivoting slot.

16. The mounting apparatus for audio module of claim 14, further comprising a second rotating rod extending from the gear; a first mounting hole is defined in the supporting plate; a second mounting hole is defined in the enclosure base; and two distal ends of the second rotating rod are pivotally mounted in the first mounting hole and the second mounting hole respectively.

17. The mounting apparatus for audio module of claim 16, wherein a dimension of the second rotating rod is equal to a dimension of the first mounting hole and a dimension of the second mounting hole.

18. The mounting apparatus for audio module of claim 11, wherein the first rotating rod rotates along a direction opposite to a rotational direction of the gear.

19. The mounting apparatus for audio module of claim 11, wherein the elastic member is a torsion spring.

20. The mounting apparatus for audio module of claim 11, wherein the audio module comprises a side surface; and a plurality of sound output holes are defined in the side surface.
